(19) United States
(12) Patent Application Publication
(10) Pub. No.: US 2024/0270657 A1
(43) Pub. Date: Aug. 15, 2024

(54) Livestock Excrement Sterilizing and Drying System Using High Temperature Combustion Gas, and Sterilizing and Drying Method

(71) Applicant: NTNECOTECH CO., LTD., Gyeonggi-do (KR)

(72) Inventors: Myung Sang RYU, Gyeonggi-do (KR); Sang Ha SHIN, Gyeonggi-do (KR); Myung Gu KANG, Gyeongsangnam-do (KR); Eung Chul LEE, Seoul (KR); Kyung Nam MOON, Gyeonggi-do (KR)

(21) Appl. No.: 18/566,747

(22) PCT Filed: Dec. 20, 2021
(86) PCT No.: PCT/KR2021/019413

§ 371 Date: Dec. 4, 2023

(30) Foreign Application Priority Data
Jun. 3, 2021 (KR) 10-2021-0072125

(51) Int. Cl. C05F 3/06; A01C 3/00; C05F 17/60; C05F 17/80; F26B 11/02

(52) U.S. Cl. CPC C05F 3/06; A01C 3/00; C05F 17/60; C05F 17/80; F26B 11/028; F26B 2200/12

(57) ABSTRACT

The present invention relates to a livestock excrement sterilizing and drying system comprising including: a grinder for pulverizing livestock excrement so as to increase the drying efficiency for the livestock excrement; a transfer unit for transferring the pulverized livestock excrement; a drying chamber which dries the livestock excrement while rotating in a state where the livestock excrement transferred by the transfer unit is inserted therein; a combustion unit for allowing a combustion gas of a combustion device to be supplied into the drying chamber in order to dry the livestock excrement inserted into the drying chamber; a dried excrement discharge unit for discharging the livestock excrement which has been dried by the combustion gas of the combustion device and has a reduced volume; and an exhaust gas processing unit for filtering an exhaust gas generated in the process of drying the livestock excrement so as to discharge the exhaust gas to the air, wherein the livestock excrement dried in the drying chamber is not burned during heat-exchange with the combustion gas, but only moisture thereof is reduced and microorganisms and odors thereof are removed.

### TECHNICAL FIELD

The present disclosure relates to a livestock excrement sterilizing and drying system and a drying method for drying livestock excrement by using high-temperature combustion gas generated by combustion in a combustion device.

### BACKGROUND ART

Due to the development of the livestock industry, the amount of excrement discharge is increasing and the excrement further includes feed and water for cleaning animal keepers, etc., thus increasing the amount of waste generated.

Livestock waste has properties as an organic fertilizer, but has a form of a mixture of solid and liquid, generates a bad odor, and is generated in large quantities, and thus is not available as a fertilizer in its entirety, and therefore is being neglected.

When livestock waste is neglected, soil, rivers, etc., are polluted by leachate, and the living environment is harmed due to the inhabitation of harmful insects, etc., such that treatment of food waste and livestock waste recently has emerged as a major social problem.

To solve this problem, food or livestock waste is treated in various ways such as a microorganism treatment method, a drying method using indirect heat, an extrusion method, a precipitation method, etc., but fails to be completely treated, and is treated for a long time, and there are problems such as odor or bacteria.

### DISCLOSURE

### Technical Problem

According to an aspect of the present disclosure, there is provided a livestock excrement sterilizing and drying system using high-temperature combustion gas and a drying method in which when livestock excrement is treated by being dried, the livestock excrement may be treated within a short time and foul odor or bacteria caused in the livestock excrement may be treated together. According to another aspect of the present disclosure, by performing drying (moisture reduction) and foul odor removal in a drying chamber without combustion of livestock excrement, livestock excrement discharged from the drying chamber is converted into fuel capable of substituting for a wood pallet, thereby supplying fuel of a renewable energy source directly available in a combined heat and power plant, an industrial boiler, a farm house facility, etc., without using a new fossil fuel.

### Technical Solution

According to an aspect of the present disclosure, a livestock excrement sterilizing and drying system includes a grinder that grinds livestock excrement to improve the efficiency of drying of the livestock excrement, a transferring unit that transfers the ground livestock excrement, a drying chamber that rotates and dries the livestock excrement while the livestock excrement transferred by the transferring unit is put thereinto, a combustion unit that supplies a combustion gas of the a combustion device into the drying chamber to dry the livestock excrement put into the drying chamber, a dried excrement discharge unit that discharges the livestock excrement of which volume has been reduced by being dried by the combustion gas of the combustion device, and an exhaust gas treatment unit that filters exhaust gas generated in a process of drying the livestock excrement to discharge the exhaust gas into the atmosphere, in which moisture may be reduced in and microorganisms and foul odor may be removed from the livestock excrement dried in the drying chamber, without combustion of the livestock excrement during heat exchange with the combustion gas.

### Advantageous Effects

The present disclosure may directly dry livestock excrement by using high-temperature combustion gas generated in combustion in a combustion device to perform drying in a short period of time, and perform drying with the high-temperature combustion gas to remove foul odor or bacteria generated in the livestock excrement together. That is, the present disclosure may directly supply the high-temperature combustion gas generated by combustion of pure fuel not including a livestock excrement component to the drying chamber without other medium, and the livestock excrement dried in the drying chamber may be dried through moisture reduction without being burned, and at the same time, bacteria and odorous components may be selectively burned by the combustion gas, such that a result discharged from the discharging chamber may contain sufficient heat energy available as a renewable energy fuel, and thus the present disclosure may provide a renewable energy fuel that may be upcycled when compared to a conventional livestock excrement treatment system that simply produces fertilizer or combusted waste.

### DESCRIPTION OF DRAWINGS

FIG. 1 shows an entire structure of a livestock excrement sterilizing and drying system using high-temperature combustion gas, according to an embodiment of the present disclosure.

FIG. 2 is a block diagram schematically showing a structure of FIG. 1.

FIG. 3 is a block diagram for describing a detailed structure of a combustion unit according to the present disclosure.

FIG. 4 is a block diagram for describing a detailed structure of an exhaust gas treatment unit according to the present disclosure.

FIG. 5 is a flowchart for describing a drying process of a livestock excrement sterilizing and drying method using high-temperature combustion gas, according to an embodiment of the present disclosure.

### BEST MODE

Hereinafter, embodiments of the present disclosure will be described with reference to the accompanying drawings.

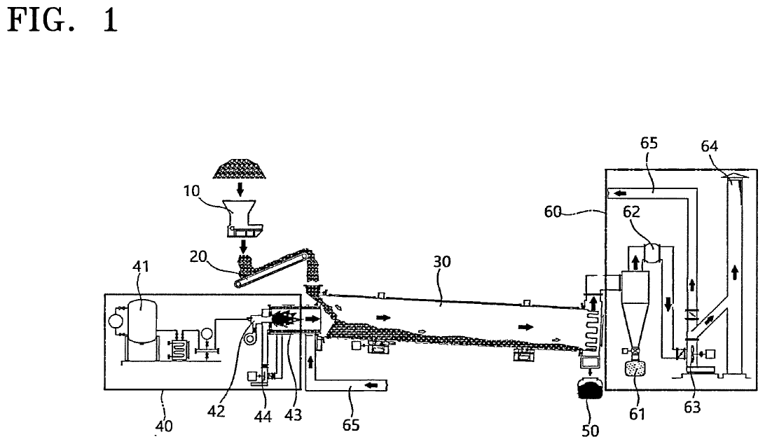

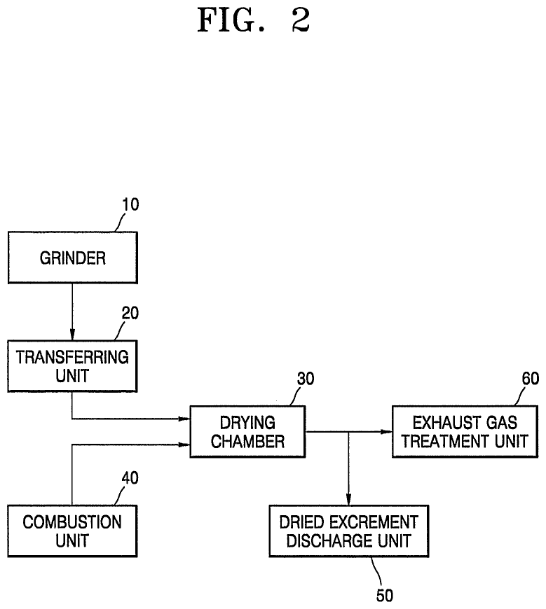

FIG. 1 is a view for describing a configuration of a livestock excrement sterilizing and drying system using high-temperature combustion gas, according to an embodiment of the present disclosure, and FIG. 2 is a block diagram schematically describing the configuration.

A livestock excrement sterilizing and drying system according to the present disclosure may include a grinder 10 that grinds livestock excrement to improve the efficiency of drying of the livestock excrement, a transferring unit 20 that transfers the ground livestock excrement, a drying chamber 30 that rotates and dries the livestock excrement while the livestock excrement transferred by the transferring unit 20 is put thereinto, a combustion unit 40 that supplies a combustion gas of the a combustion device 42 into the drying chamber 30 to dry the livestock excrement put into the drying chamber 30, a dried excrement discharge unit 50 that discharges the livestock excrement of which volume has been reduced by being dried by the combustion gas of the combustion device 42, and an exhaust gas treatment unit 60 that filters exhaust gas generated in a process of drying the livestock excrement to discharge the exhaust gas into the atmosphere.

The grinder 10 may finely grind livestock excrement to efficiently dry the livestock excrement, and the ground livestock excrement may be transferred by the transferring unit 20 installed thereunder.

In an embodiment, the transferring unit 20 may be installed in the form of a conveyor and transfer the ground livestock excrement to the drying chamber 30.

The livestock excrement transferred by the transferring unit 20 may be put into the drying chamber 30 to dry the livestock excrement, and a dryer in a rotary kiln form may be installed as the drying chamber 30.

The drying chamber 30 may uniformly mix dried livestock excrement and undried livestock excrement in a process of continuously putting the ground livestock excrement to prevent the livestock excrement from clumping or being tangled due to moisture, and may effectively mix the livestock excrement using a plurality of wings included therein to improve the performance of drying.

Moreover, in the present disclosure, the combustion unit 40 may be provided which may dry the livestock excrement fast and may burn and remove foul odor and bacteria generated in drying of the livestock excrement by the high-temperature combustion gas, by supplying high-temperature combustion gas due to combustion in the combustion device 42 when the livestock excrement is dried by the drying chamber 30.

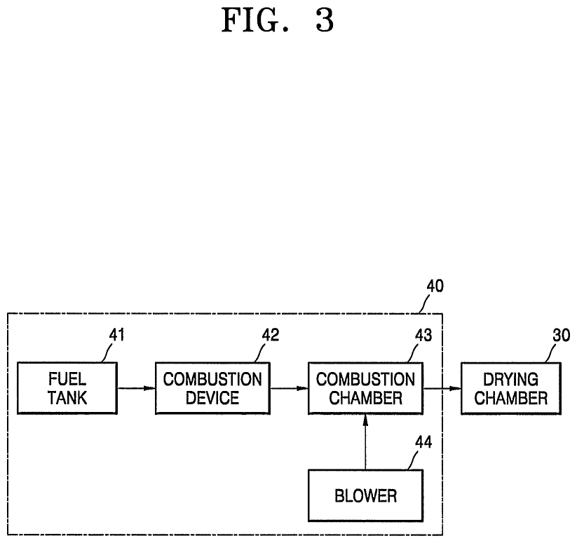

FIG. 3 is a block diagram for describing a detailed structure of the combustion unit 40 according to the present disclosure.

The combustion unit 40 may include a fuel tank 41 that supplies fuel for combustion, a combustion device 42 that burns the fuel of the fuel tank 41, a combustion chamber 43 in which a combustion gas is generated in combustion by the combustion device 42, and a blower 44 that supplies the combustion gas generated in a combustion pipe to the drying chamber 30 while keeping constant the amount of combustion gas, a flow rate of the combustion gas, and the temperature of the combustion gas during combustion by the combustion device 42.

The fuel tank 41 may use liquefied petroleum gas (LPG) and may include a vaporizer installed therein to evaporate a liquid fuel to supply the LPG for combustion.

The combustion device 42 may burn fuel to generate high-temperature combustion gas, and the combustion gas generated by combustion in the combustion chamber 43 may be directly supplied to the drying chamber 30 to allow the livestock excrement to be dried efficiently.

In this case, the blower 44 may be installed to allow the livestock excrement to be dried in an optimized state through efficient combustion in the combustion chamber 43, and may optimize a combustion speed, an optimal combustion ratio between fuel and air, the amount of combustion gas, a flow rate of the combustion gas, and a temperature condition of the combustion gas in the combustion chamber 43.

In an embodiment, the temperature of the combustion gas generated in the combustion chamber 43 may be adjusted by the blower 44, and the combustion gas of a temperature of 800 to 1550° C. may be generated to remove the foul odor generated in drying of the livestock excrement.

Generally, as a smell like foul odor disappears in case of combustion for 2 to 3 seconds above 800° C., the temperature of the combustion gas generated in the combustion chamber 43 may be adjusted by the blower 44 such that the temperature of the combustion gas is 800° C. or higher.

In addition, at this temperature, not only the foul odor but also the bacteria may be removed together. That is, a key feature of the present disclosure is that livestock excrement dried in the drying chamber 30 may not be burned during heat exchange with the combustion gas, and only moisture may be reduced and microorganisms and the foul odor may be removed. More specifically, in a process of drying the livestock excrement put into the drying chamber 30 while directly contacting the high-temperature combustion gas in the drying chamber 30, the livestock excrement may be merely dried (moisture may be reduced) and only the foul odor may be removed, without burning the livestock excrement, such that the livestock excrement discharged from the drying chamber 30 may be used directly as a renewable raw material available in power plants, industrial boilers, farm house facilities, etc., without mixing additional additives. That is, a key configuration of the present disclosure is that the temperature of the drying chamber 30 may be controlled to dry the livestock excrement and remove the foul odor without combustion of the livestock excrement, in spite of heat exchange between the livestock excrement and the combustion gas by direct contact therebetween.

Referring back to FIG. 2, the livestock excrement having been dried by the drying chamber 30 may be separately disposed by being discharged through the dried excrement discharge unit 50, and the exhaust gas generated during drying may be filtered through the exhaust gas treatment unit 60, thus being discharged into the atmosphere.

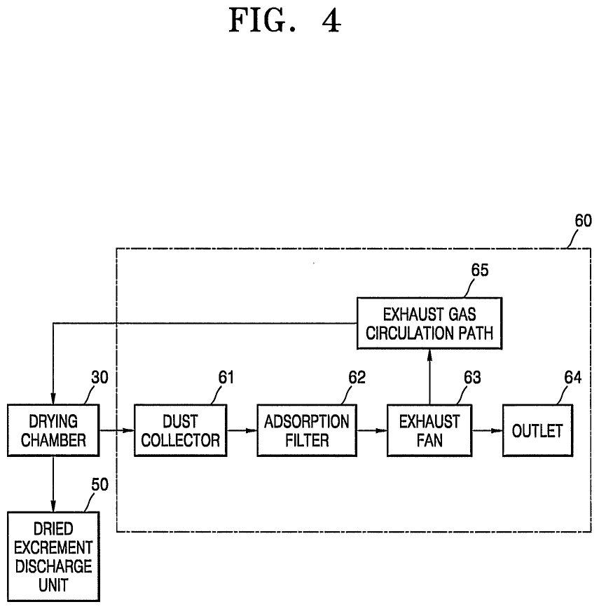

FIG. 4 is a block diagram for describing a detailed structure of the exhaust gas treatment unit 60 according to the present disclosure.

The exhaust gas treatment unit 60 according to the present disclosure may include a dust collector 61 that removes foreign substances such as dust contained in the exhaust gas before discharging of the exhaust gas generated during drying, an adsorption filter 62 that filters odors that are not removed during drying in the drying chamber 30 to prevent the odors from being discharged with the exhaust gas, an exhaust fan 63 that maintains pressure inside the drying chamber 30 at a negative pressure such that the livestock excrement is brought into contact with the combustion gas and is dried, thereby preventing heat, dust, and odor generated during drying from being discharged to the outside, an exhaust gas circulation path 65 to increase drying efficiency by recirculating part of the exhaust gas having passed through the adsorption filter 62 into the combustion chamber 43 before being discharged into the atmosphere, and an outlet 64 that discharges the exhaust gas from which the odor and the foreign substances have been removed into the atmosphere.

The dust collector 61 may be installed to remove foreign substances such as dust or ash contained in the exhaust gas sucked and discharged through the exhaust fan 63 after drying of the livestock excrement, and may also remove condensed moisture.

The exhaust gas from which the foreign substances are removed by the dust collector 61 may pass through the adsorption filter 62 to finally remove the foul odor not removed by the high-temperature combustion gas during drying in the drying chamber 30.

The foul odor generated during drying of the livestock excrement may be mostly removed by the combustion gas, but the remaining partial odor may be discharged through the exhaust gas, and thus may be further filtered by the adsorption filter 62 to discharge the exhaust gas from which a harmful substance has been removed.

The exhaust fan 63 may be installed at the rear end of the adsorption filter 62 to maintain pressure in the drying chamber 30 at negative pressure to prevent heat, dust, and odor generated in drying from being discharged to the outside while allowing the exhaust gas to be discharged and circulated.

The exhaust gas from which the foreign substances and the odor are removed through the dust collector 61 and the adsorption filter 62 may be discharged into the atmosphere through the outlet 64, and the discharged exhaust gas may not include CO, CO₂, NOx, etc., thus preventing environmental contamination.

The partial exhaust gas discharged at this time may be reused by being circulated back to the exhaust gas circulation path 65, thereby improving drying efficiency. The exhaust gas circulated to the combustion chamber 43 through the exhaust gas circulation path 65 may enable the livestock excrement dried in the drying chamber 30 to be dried without being burned, by adjusting the temperature of the combustion gas supplied to the drying chamber 30 and controlling the concentration of oxygen O₂ of a portion contacting the combustion gas. The discharged exhaust gas may contain heat, such that a discharged heat source may be reused, thereby reducing consumption of heat energy.

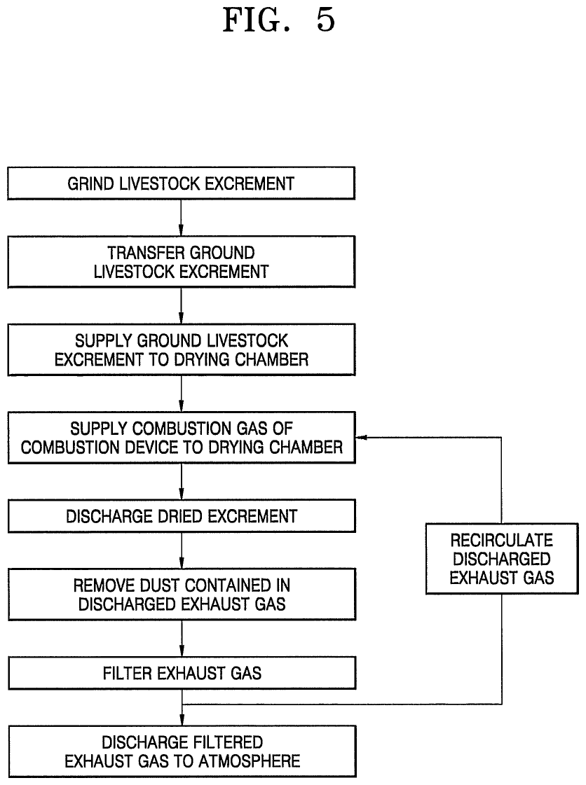

Hereinbelow, a method of sterilizing and drying livestock excrement by using high-temperature combustion gas will be described with reference to FIG. 5.

First, the livestock excrement to be dried may be finely ground by the grinder 10 to facilitate drying of the livestock excrement.

The ground livestock excrement may be transferred by the transferring unit 20, and the transferred livestock excrement may be supplied to the drying chamber 30 to dry the ground livestock excrement.

As the livestock excrement supplied to the drying chamber 30 is supplied, the drying chamber 30 may mix and dry the put livestock excrement while rotating, and supply the high-temperature combustion gas generated by combustion in the combustion device 42 into the drying chamber 30 to dry the combustion gas within a short time, thereby removing the foul odor and the bacteria generated during drying. More specifically, in the drying process, the combustion gas may be directly supplied from the combustion device 42, and moisture may be reduced in and microorganisms and foul odor may be removed from the dried livestock excrement during heat exchange with the combustion gas.

The livestock excrement having been dried by the drying chamber 30 may be separately discharged and treated through the dried excrement discharge unit 50, and the exhaust gas generated during drying may be guided and discharged through the installed exhaust fan 63.

The foreign substances, such as dust, contained in the discharged exhaust gas may be removed through the dust collector 61, and after removal of the foreign substances, the exhaust gas may be filtered to remove the odor of the exhaust gas again through the adsorption filter 62.

The foreign substances and the odor may be removed by the dust collector 61 and the adsorption filter 62, such that a harmless exhaust gas may be discharged into the atmosphere through the outlet 64 and part of the discharged exhaust gas may be circulated to the combustion chamber 43 through the exhaust gas circulation path 65 so as to be reused.

In the foregoing description of the present disclosure, the specific embodiment is described, but various changes may be carried out without deviating from the scope of the present disclosure. Therefore, the scope of the present disclosure shall not be determined by the described embodiment, but should be determined by claims and equivalents thereof.

### MODE FOR INVENTION

A livestock excrement sterilizing and drying system according to the present disclosure may include a grinder 10 that grinds livestock excrement to improve the efficiency of drying of the livestock excrement, a transferring unit 20 that transfers the ground livestock excrement, a drying chamber 30 that rotates and dries the livestock excrement while the livestock excrement transferred by the transferring unit 20 is put thereinto, a combustion unit 40 that supplies combustion gas of the a combustion device 42 into the drying chamber 30 to dry the livestock excrement put into the drying chamber 30, a dried excrement discharge unit 50 that discharges the livestock excrement of which volume has been reduced by being dried by the combustion gas in the combustion device 42, and an exhaust gas treatment unit 60 that filters exhaust gas generated in a process of drying the livestock excrement to discharge the exhaust gas into the atmosphere, in which moisture may be reduced in and microorganisms and foul odor may be removed from the livestock excrement dried in the drying chamber 30, without combustion of the livestock excrement during heat exchange with the combustion gas.

The combustion unit 40 may include a fuel tank 41 that supplies fuel for combustion, a combustion device 42 that burns the fuel of the fuel tank 41, a combustion chamber 43 in which a combustion gas is generated in combustion by the combustion device 42, and a blower 44 that supplies the combustion gas generated in a combustion pipe to the drying chamber 30 while keeping constant the amount of combustion gas, a flow rate of the combustion gas, and the temperature of the combustion gas during combustion by the combustion device 42.

In addition, a temperature of the combustion gas generated in the combustion unit 40 may be 800 to 1550° C.

The exhaust gas treatment unit 60 may include a dust collector 61 that removes foreign substances such as dust contained in the exhaust gas before discharging of the exhaust gas generated during drying, an adsorption filter 62 that filters odors that are not removed during drying in the drying chamber 30 to prevent the odors from being discharged with the exhaust gas, an exhaust fan 63 that maintains pressure inside the drying chamber 30 at a negative pressure such that the livestock excrement is brought into contact with the combustion gas and is dried, thereby preventing heat, dust, and odor generated during drying from being discharged to the outside, and an outlet 64 that discharges the exhaust gas from which the odor and the foreign substances have been removed into the atmosphere.

A livestock excrement sterilizing and drying method according to the present disclosure may include grinding, by the grinder, livestock excrement to be dried to facilitate drying of the livestock excrement, transferring, by the transferring unit 20, the ground livestock excrement, supplying the ground livestock excrement to the drying chamber 30 for drying the ground livestock excrement, mixing and drying the livestock excrement put into the drying chamber 30 to which the livestock excrement is supplied, through rotation of the drying chamber 30, and supplying high-temperature combustion gas generated by combustion in the combustion device 42 into the drying chamber 30 to dry the livestock excrement, discharging the livestock excrement having been dried by the drying chamber 30 through the dried excrement discharge unit 50, guiding exhaust gas generated in drying and discharged to be discharged by the exhaust fan 63 and removing foreign substances contained in the exhaust gas through the dust collector 61, filtering the exhaust gas from which the foreign substance is removed, to remove an odor through the adsorption filter 62, and discharging, into the atmosphere through the outlet 64, harmless exhaust gas from which the foreign substance and the odor have been removed by the adsorption filter 62, in which in the drying, the combustion gas may be directly supplied from the combustion device 42, and moisture may be reduced in and microorganisms and foul odor may be removed from the dried livestock excrement during heat exchange with the combustion gas.

1. A livestock excrement sterilizing and drying system using high-temperature combustion gas, comprising:
a grinder grinding livestock excrement to increase drying efficiency;
a transferring unit transferring the ground livestock excrement;
a drying chamber rotating and drying the livestock excrement, while the livestock excrement transferred by the transferring unit is put thereinto;
a combustion unit supplying a combustion gas of a combustion device into the drying chamber to dry the livestock excrement put into the drying chamber;
a dried excrement discharge unit discharging the livestock excrement of which volume has been reduced by being dried by the combustion gas of the combustion device; and
an exhaust gas treatment unit filtering exhaust gas generated during drying of the livestock excrement, to discharge the exhaust gas into the atmosphere,
wherein moisture is reduced in and microorganisms and foul odor are removed from the livestock excrement dried in the drying chamber, without combustion of the livestock excrement during heat exchange with the combustion gas.

2. The livestock excrement sterilizing and drying system of claim 1, wherein the combustion unit comprises:
a fuel tank supplying fuel for combustion in the combustion device;
a combustion device burning the fuel of the fuel tank;
a combustion chamber in which the combustion gas generated in combustion by the combustion device is generated; and
a blower supplying the combustion gas generated in a combustion pipe to the drying chamber while keeping constant an amount of combustion gas, a flow rate of the combustion gas, and a temperature of the combustion gas in combustion by the combustion device.

3. The livestock excrement sterilizing and drying system of claim 2, wherein a temperature of the combustion gas generated in the combustion unit is 800 to 1550° ° C.

4. The livestock excrement sterilizing and drying system of claim 1, wherein the exhaust gas treatment unit comprises:
a dust collector removing foreign substances, such as dust, contained in the exhaust gas generated in drying, before discharging of the exhaust gas;
an adsorption filter filtering foul odor not removed during drying in the drying chamber, to prevent the foul odor from being discharged together with the exhaust gas;
an exhaust fan maintaining pressure inside the drying chamber at negative pressure so that the livestock excrement is brought into contact with the combustion gas and dried, to thereby prevent heat, dust, and odor generated in drying from being discharged to outside; and
an outlet discharging, into the atmosphere, the exhaust gas from which the odor and the foreign substances have been removed.

5. A livestock excrement sterilizing and drying method comprising:
grinding, by a grinder, livestock excrement to be dried to facilitate drying of the livestock excrement;
transferring, by a transferring unit, the ground livestock excrement;
supplying the ground livestock excrement to a drying chamber for drying the ground livestock excrement;
mixing and drying the livestock excrement put into the drying chamber to which the livestock excrement is supplied, through rotation of the drying chamber, and supplying high-temperature combustion gas generated by combustion in a combustion device into the drying chamber to dry the livestock excrement;
discharging the livestock excrement having been dried by the drying chamber, through the dried excrement discharge unit;
guiding exhaust gas generated in drying and discharged to be discharged by an exhaust fan and removing foreign substances contained in the exhaust gas through a dust collector;
filtering the exhaust gas from which the foreign substances have been removed, to remove odor through an adsorption filter; and
discharging, into the atmosphere through the outlet, harmless exhaust gas from which the foreign substances and the odor have been removed by the adsorption filter,
wherein in the drying, the combustion gas is directly supplied from the combustion device, and moisture is reduced in and microorganisms and foul odor are removed from the dried livestock excrement during heat exchange with the combustion gas.
